(19) United States
(12) Patent Application Publication
(10) Pub. No.: US 2010/0270012 A1
(43) Pub. Date: Oct. 28, 2010

(54) AUTOMOTIVE HEAT EXCHANGER TO THE UNIFICATION OF HEADER AND TANK AND FABRICATING METHOD THEREOF

(75) Inventors: Kon Hur, Daegu (KR); Jung-Soo Bae, Daegu (KR); Woon-Hyeuk Han, Daegu (KR); Rak-Gyun Kim, Daegu (KR); Kyung-Min Woo, Daegu (KR)

Correspondence Address: DILWORTH & BARRESE, LLP, 1000 WOODBURY ROAD, SUITE 405, WOODBURY, NY, 11797, US

(73) Assignee: KOREA DELPHI AUTOMOTIVE SYSTEMS CORPORATION, Dalseong-Gun, Daegu (KR)

(21) Appl. No.: 12/310,378

(22) PCT Filed: Sep. 20, 2007
(86) PCT No.: PCT/KR2007/004593

§ 371 Date: Feb. 23, 2009

(30) Foreign Application Priority Data
Sep. 25, 2006 (KR) 10-2006-0092718
Sep. 14, 2007 (KR) 10-2007-0093377

(51) Int. Cl. F28F 9/02; B21D 53/02; B23P 15/26

(52) U.S. Cl. 165/173; 29/890.03; 29/890.054

(57) ABSTRACT

There are provided an automobile heat exchanger having a header formed integrally with a tank and a method of manufacturing the same, and, more particularly, an automobile heat exchanger comprising a top header pipe unit formed of a pair of header pipes and a bottom header pipe unit formed of a pair of header pipes, the top header pipe unit to be connected to top ends of tubes and the bottom header pipe unit to be connected to bottom ends thereof, and the header pipe including a header formed integrally with a tank. In the heat exchanger, each header pipe is manufactured in a welded type or folded type so that the header is formed integrally with the tank. Accordingly, unlike a conventional heat exchanger, the present invention does not require any separate metal mold or assembling means for assembling the header and tank. Consequently, the manufacturing cost is reduced and the manufacturing time is shortened by simplifying the processes. Furthermore, the pressure strength in the header-tank increases and the risk of leaking a heat exchanging medium decreases, to increase the efficiency of heat exchange. Further, the width wise sectional shapes of the top and bottom header pipe units are controlled so that the condensate generated on the surface of a plurality of the header pipes is easily discharged.

### TECHNICAL FIELD

The present invention relates to an automobile heat exchanger having a header formed integrally with a tank, and a method of manufacturing the same.

### BACKGROUND ART

A heat exchanger is formed by connecting a plurality of tubes between a pair of header tanks and is positioned at a path of a cooling or heating system. The heat exchanger is an air conditioning device for cooling or heating an inside space by performing the heat exchange using an outside air when a heat exchanging medium which is supplied through an entrance unit for the heat exchanging medium, which is formed at one side of the header tank, passes through the tubes and by allowing the heat exchanging medium to be released through an exit unit for the heat exchanging medium.

Various heat exchangers are mounted on an automobile, for adjusting an inside temperature condition of the automobile to that desired by a passenger, and for cooling the heat generated by an engine of the automobile. These heat exchangers include an evaporator for cooling the inside of the automobile, a heater core for warming the inside of the automobile, a radiator for cooling the engine of the automobile, a condenser for condensing a refrigerant rising from the evaporator, and others.

The present invention is related to an evaporator among the aforementioned heat exchangers for an automobile. A conventional evaporator comprises a plurality of tubes and fins, a header connected to both ends of the tube, and a tank connected to the header, to form a header tank.

However, in a conventional evaporator, since the header and the tank are separately manufactured and these are connected to each other by brazing joining, the working efforts increase. Moreover, since a heat exchanging medium easily leaks at a brazing joint part between the header and the tank, the heat exchanging performance decreases.

U.S. Pat. No. 6,272,881 B1 and Korean Patent Laid-Open Publication 10-2004-0069048 have provided the heat exchangers to solve the aforementioned problems. However, both heat exchangers lack heat radiation in technology and performance. Korean Patent Laid-Open Publication 10-2006-0020246 further provides a heat exchanger comprising a tube-type header in which the header is formed integrally with a tank, and a separate main partitioning means for dividing an inside space of the tube-type header into a plurality of columns. However, in Korean Patent Laid-Open Publication 10-2006-0020246, since it is difficult to connect the tube-type header and the main partitioning means to each other and to accurately assemble them together, a heat exchanging medium easily leaks.

Moreover, as the high performance of heat exchange has been required, excessive condensate is generated on the surface of a fin and a header of an evaporator. To solve this problem, Japanese Patent Laid-Open Publication 2006-207994 has provided a separate drainage accelerating member to be positioned between tubes. However, when the separate drainage accelerating member is positioned between the tubes for draining the condensate, the manufacturing work of forming the drainage accelerating member and the manufacturing cost thereof increase and the condensate generated on the surface of a header unit is not easily drained.

Further, in the conventional evaporator, the constituent elements, such as the header, tank and tube, are connected by the brazing joining after the header and the tank are manufactured by press molding or extrusion molding and a clad material is pressed toward the header. However, the method of pressing the clad material causes a brazing fail when the clad material comes off during transportation.

### DISCLOSURE OF INVENTION

### Technical Problem

Therefore, the present invention has been made to solve the above problems, and it is an object of the present invention to provide an automobile heat exchanger having a header formed-integrally with a tank, and a method of manufacturing the same, in which a header pipe is formed of a header and a tank being integrally formed, a pair of header pipes are connected to a top end of a tube and another pair of header pipes are connected to a bottom end of the tube so that there is no need to separate from or connect to the header and the tank, and in which a plurality of header units are formed by connecting an entrance/exit end cap and an end cap to both ends of each of the header pipes to be securely assembled together, and a plurality of refrigerant flowing means are bored, spaced apart from one another at a predetermined distance, on one lengthwise side of the header pipe so that a refrigerant flows between the header pipes, to improve refrigerant distribution and heat radiation.

It is another object of the present invention to provide an automobile heat exchanger having a header formed integrally with a tank, and a method of manufacturing the same, in which each header pipe is formed in a welded type by rolling a board with a clad material in a cylindrical shape, welding both edges of the board, passing the board through a drawing metal mold, and then boring tube inserting holes to be connected to tubes and refrigerant flowing means by a pressing process, or in which each header pipe is formed in a folded type by boring tube inserting holes and refrigerant flowing means on a board with a clad material by a pressing process, forming a flat surface to be joined between the header pipes by a folding process, bending both edges of the board to face each other and to be connected to each other by brazing joining.

The other objects and advantages of the present invention will be described below and become apparent by the embodiments of the present invention. Further, the objects and advantages of the present invention will be realized by the elements set forth in the claims and the combination thereof.

### Technical Solution

In accordance with an embodiment, the present invention provides an automobile heat exchanger having a header formed integrally with a tank, which comprises:

a plurality of tubes through which a heat exchanging fluid flows and which are spaced apart from one another at a predetermined distance, a top header pipe unit to be operatively connected to top ends of the tubes, and a bottom header pipe unit to be operatively connected to bottom ends of the tubes;

wherein each of the top header pipe unit and the bottom header pipe unit is formed of a pair of header pipes formed of one component so that a header is formed integrally with a tank, and the pair of the header pipes each have a flat surface formed at one lengthwise side of the header pipe so as to correspond to each other and to be connected to each other at the one side;

wherein the top header pipe unit comprises: a first header pipe into which the heat exchanging fluid flows, a second header pipe from which the heat exchanging fluid flows out, an entrance/exit end cap to be connected to one, end of each of the first and second header pipes, forming an inlet aperture and an outlet aperture for the heat exchanging fluid, and an end cap to be connected to the other end of each of the first and second header pipes and connecting the first and second header pipes so as to be securely assembled together, and

wherein the bottom header pipe unit comprises: a third header pipe for receiving the heat exchanging fluid transferred from the first header pipe, a fourth header pipe for flowing the heat exchanging fluid into the second header pipe, a plurality of refrigerant flowing means bored to be spaced apart at a predetermined distance at one lengthwise side of each of the third and fourth header pipes, in the same shape and in the same number, so as to face each other at a joint part between the third and fourth header pipes, so that the heat exchanging fluid flows between the third and fourth header pipes through the refrigerant flowing means, and a pair of end caps to be each connected to both ends of each of the third and fourth header pipes and connecting the third and fourth header pipes to be securely assembled together.

In accordance with another embodiment, the present invention provides an automobile heat exchanger having a header formed integrally with a tank, which comprises:

a plurality of tubes through which a heat exchanging fluid flows and which are spaced apart from one another at a predetermined distance, a top header pipe unit to be operatively connected to top ends of the tubes, and a bottom header pipe unit to be operatively connected to bottom ends of the tubes;

wherein each of the top header pipe unit and the bottom header pipe unit is formed of a pair of header pipes formed of one component so that a header is formed integrally with a tank, and the pair of the header pipes each have a flat surface formed at one lengthwise side of the header pipe so as to correspond to each other and to be connected to each other at the one side;

wherein the top header pipe unit comprises: a first header pipe connecting an inlet manifold so that the heat exchanging fluid flows into, a second header pipe connecting an outlet manifold so that the heat exchanging fluid flows out, an entrance/exit end cap to be connected to one side of each of the first and second header pipes and forming an inlet aperture for the heat exchanging fluid, and an end cap to be connected to the other side of each of the first and second header pipes and connecting the first and second header pipes to be securely assembled together; and

wherein the bottom header pipe unit comprises: a third header pipe for receiving the heat exchanging fluid transferred from the first header pipe, a fourth header pipe for flowing the heat exchanging fluid into the second header pipe, a plurality of refrigerant flowing means bored to be spaced apart at a predetermined distance at one lengthwise side of each of the third and fourth header pipes, in the same shape and in the same number, so as to face each other at a joint part between the third and fourth header pipes, so that the heat exchanging fluid flows between the third and fourth header pipes through the refrigerant flowing means, and a pair of end caps to be each connected to both ends of each of the third and fourth header pipes and connecting the third and fourth header pipes to be securely assembled together.

Further, each of the header pipes is manufactured by steps of: forming a board with a clad material in a cylindrical shape; welding both facing edges of the board formed in the cylindrical shape; passing the welded cylindrical board through a drawing metal mold so that the board is drawn to form a flat surface on one side thereof; performing a pressing process to form tube inserting holes at one side of the drawn board; and performing a pressing process to form refrigerant flowing means on the flat surface.

Alternatively, each of the header pipes are manufactured by steps of: performing a pressing process to form tube inserting holes on a board with a clad material; performing a pressing process to form refrigerant flowing means at a position corresponding to a flat surface; performing a folding process to form the flat surface at a position spaced apart from both ends of the tube inserting holes by at least 0.2 mm or more; and performing a bending process to the board so that both edges thereof face each other.

### ADVANTAGEOUS EFFECTS

As described above, the heat exchanger according to the present invention in which the header pipes are connected to both ends of the tubes has the effects that, since the header and the tank are formed integrally, the header is not needed to be separated from or connected to the tank; since a plurality of refrigerant flowing means for flowing the refrigerant between the header pipes are bored to be spaced apart from one another at a predetermined distance at one lengthwise side and the entrance/exit end cap and the end cap are securely connected to both ends of each of the header pipes to form a plurality of header units, the pressure capability of the heat exchanger increases and a ratio of radiant heat is improved.

Furthermore, since the header pipe in which the header and the tank are formed integrally is formed in a welded type or a folded type and a pair of the header pipes are joined by surfaces at one side to form the top and bottom header pipe units, the header and the tank do not need to be separately manufactured to be joined, and the header and the tank can be manufactured without any additional metal mold and connecting means. Consequently, the productivity is improved by simplifying the manufacturing process, the manufacturing cost and time are reduced, the risk of leaking the heat exchanging medium is reduced by solving the problems of conventional heat exchangers which have the high risk of leaking the heat exchanging medium due to a lot of brazing parts, the pressure strength is increased, the widthwise sectional shape of each header pipe unit is controlled to make it easy to discharge the condensate generated on the surface of the plurality of header pipes, and the clad material is prevented from coming off during transportation so that no brazing fail occurs.

### BRIEF DESCRIPTION OF THE DRAWINGS

These and other aspects and advantages of the present invention will become apparent and more readily appreciated from the following description of the embodiments, taken in conjunction with the accompanying drawings, in which:

FIG. 1 is a perspective view of a heat exchanger according to an embodiment of the present invention;

FIG. 2 is a perspective view of a heat exchanger according to another embodiment of the present invention;

FIG. 3 is a perspective view of refrigerant flowing means according to the present invention;

FIGS. 4 and 5 illustrate a first exemplary view of a method of manufacturing a header pipe according to the present invention;

FIGS. 6 and 7 illustrate a second exemplary view of a method of manufacturing a header pipe according to the present invention;

FIG. 8 is a sectional view of an example of the header pipe according to the present invention;

FIG. 9 is a sectional view of the refrigerant flowing means and the flat surface according to the present invention;

FIG. 10 is a graph of the correlation between the flat surface and the refrigerant flowing means and a ratio of radiant heat according to the present invention;

FIG. 11 is a graph of the correlation between the flat surface and the refrigerant flowing means and the pressure drop of a refrigerant according to the present invention;

FIG. 12 is a graph of the correlation between the flat surface and the refrigerant flowing means and the leak occurrence at a joint part of the flat surfaces of the header pipes according to the present invention;

FIG. 13 is a graph of the correlation between the sectional diameter of the header pipe and a ratio of radiant heat; and

FIG. 14 is a graph of the correlation between the distance of the refrigerant flowing means formed on the flat surface of the header pipe and a ratio of radiant heat.

### EXPLANATION ON ESSENTIAL ELEMENTS OF DRAWINGS

10: top header pipe unit
11: first header pipe
12: second header pipe
13: bottom header pipe unit
14: third header pipe
15: fourth header pipe
16: tube inserting hole
17: connection hole
20, 20′: entrance/exit end cap
30: end cap
31: flat surface
40: tube
50: heat exchanging fluid
60: refrigerant flowing means
61: board
70: inlet manifold
72: outlet manifold
80: pressure roller
81: induction coil
82: drawing tool

### BEST MODE FOR CARRYING OUT THE INVENTION

Detailed illustrative embodiments of the present invention are disclosed herein. This invention may, however, be embodied in many alternate forms and should not be construed as limited to only the embodiments of the present invention set forth herein. Accordingly, while embodiments of the present invention are capable of various modifications and alternative forms, embodiments of the present invention are shown by way of example in the drawings and will herein be described in detail.

It will be understood that when a direction of an apparatus or an element is referred to as, for example, “front”, “back”, “up”, “down”, “top”, “bottom”, “left”, “right” and “lateral”, these terms are used to simply and clearly describe the present invention and are not intended to simply mean that the apparatus or element should have a specific direction.

It will be also understood that, although the terms, such as “first”, “second”, “third” and “fourth”, these terms are used to clearly describe the present invention in the specification and claims and are not intended to indicate or mean any relative importance or purpose.

The present invention to accomplish the above objects has the characteristics described below:

In an aspect of the present invention, there is provided an automobile heat exchanger having a header formed integrally with a tank.

In accordance with an embodiment, the present invention provides an automobile heat exchanger having a header formed integrally with a tank, which comprises:

a plurality of tubes through which a heat exchanging fluid flows and which are spaced apart from one another at a predetermined distance, a top header pipe unit to be operatively connected to top ends of the tubes, and a bottom header pipe unit to be operatively connected to bottom ends of the tubes;

wherein each of the top header pipe unit and the bottom header pipe unit is formed of a pair of header pipes formed of one component so that a header is formed integrally with a tank, and the pair of the header pipes each have a flat surface formed at one lengthwise side of the header pipe so as to correspond to each other and to be connected to each other at the one side;

wherein the top header pipe unit comprises: a first header pipe into which the heat exchanging fluid flows, a second header pipe from which the heat exchanging fluid flows out, an entrance/exit end cap to be connected to one end of each of the first and second header pipes, forming an inlet aperture and an outlet aperture for the heat exchanging fluid, and an end cap to be connected to the other end of each of the first and second header pipes and connecting the first and second header pipes so as to be securely assembled together; and

wherein the bottom header pipe unit comprises: a third header pipe for receiving the heat exchanging fluid transferred from the first header pipe, a fourth header pipe for flowing the heat exchanging fluid into the second header pipe, a plurality of refrigerant flowing means bored to be spaced apart at a predetermined distance at one lengthwise side of each of the third and fourth header pipes, in the same shape and in the same number, so as to face each other at a joint part between the third and fourth header pipes, so that the heat exchanging fluid flows between the third and fourth header pipes through the refrigerant flowing means, and a pair of end caps to be each connected to both ends of each of the third and fourth header pipes and connecting the third and fourth header pipes to be securely assembled together.

In accordance with another embodiment, the present invention provides an automobile heat exchanger having a header formed integrally with a tank, which comprises:

a plurality of tubes through which a heat exchanging fluid flows and which are spaced apart from one another at a predetermined distance, a top header pipe unit to be operatively connected to top ends of the tubes, and a bottom header pipe unit to be operatively connected to bottom ends of the tubes;

wherein each of the top header pipe unit and the bottom header pipe unit is formed of a pair of header pipes formed of one component so that a header is formed integrally with a tank, and the pair of the header pipes each have a flat surface formed at one lengthwise side of the header pipe so as to correspond to each other and to be connected to each other at the one side;

wherein the top header pipe unit comprises: a first header pipe connecting an inlet manifold so that the heat exchanging fluid flows into, a second header pipe connecting an outlet manifold so that the heat exchanging fluid flows out, an entrance/exit end cap to be connected to one side of each of the first and second header pipes and forming an inlet aperture for the heat exchanging fluid, and an end cap to be connected to the other side of each of the first and second header pipes and connecting the first and second header pipes to be securely assembled together; and

wherein the bottom header pipe unit comprises: a third header pipe for receiving the heat exchanging fluid transferred from the first header pipe, a fourth header pipe for flowing the heat exchanging fluid into the second header pipe, a plurality of refrigerant flowing means bored to be spaced apart at a predetermined distance at one lengthwise side of each of the third and fourth header pipes, in the same shape and in the same number, so as to face each other at a joint part between the third and fourth header pipes, so that the heat exchanging fluid flows between the third and fourth header pipes through the refrigerant flowing means, and a pair of end caps to be each connected to both ends of each of the third and fourth header pipes and connecting the third and fourth header pipes to be securely assembled together.

Further, each of the first, second, third and fourth header pipes is formed by rolling a board with a clad material in a cylindrical shape, welding both facing edges thereof, and passing the welded cylindrical board through a drawing metal mold.

Further, each of the first, second, third and fourth header pipes is formed by forming tube inserting holes to receive the tubes and refrigerant flowing means by performing a pressing process on the board with the clad material, forming a flat surface by a folding process, and performing a bending process on the both edges of the processed board to face each other so that the both edges are joined upon brazing.

Further, the tube is manufactured by extrusion molding and includes a plurality of protrusions for expanding a heat transfer area formed around a tube hole by the extrusion molding.

Further, the tube is manufactured by forming an outer circumferential surface using a board member with a clad, and by inserting a heat transfer expanding member of a refrigerant inside.

Further, the joint part between the first and second header pipes and the joint part between the third and fourth header pipes use a clad member or clad paste during a brazing process, so that each pair of the header pipes are integrally welded.

Further, the top header pipe unit has a widthwise sectional shape W1 in which portions of the surfaces joining the first and second header pipes are drawn downward, and the bottom header pipe unit has a widthwise section shape W2 in which portions of the surfaces joining the third and fourth header pipes are drawn upward.

Further, the first, second, third and fourth header pipes each have a sectional shape of “D” in which the flat surface is formed at one lengthwise side.

Further, the first, second, third and fourth header pipes each have a ratio of a height (H′) of the refrigerant flowing means to a height (H) of the flat surface formed at the one lengthwise side, within the range of 0.3 to 0.7.

Further, the first, second, third and fourth header pipes each have a thickness of the board within the range of 0.5 to 1.5 mm, and a sectional diameter D of the header pipe within the range of 10 to 24 mm.

Further, the first, second, third and fourth header pipes each have a distance between the refrigerant flowing means formed on the flat surface at the one side, within the range of 6 to 12 mm.

Further, the refrigerant flowing means has a shape in which its area progressively decreases or increases toward one lengthwise side of the third and fourth header pipes.

Further, the first, second, third and fourth header pipes are manufactured in a welded type by steps of: forming a board with a clad material in a cylindrical shape; welding both facing edges of the board formed in the cylindrical shape; passing the welded cylindrical board through a drawing metal mold so that the board is drawn to form a flat surface on one side thereof; performing a pressing process to form tube inserting holes at one side of the drawn board; and performing a pressing process to form refrigerant flowing means on the flat surface.

Alternatively, the first, second, third and fourth header pipes are manufactured in a folded type by steps of: performing a pressing process to form tube inserting holes on a board with a clad material; performing a pressing process to form refrigerant flowing means at a position corresponding to a flat surface; performing a folding process to form the flat surface at a position spaced apart from both ends of the tube inserting holes by at least 0.2 mm or more; and performing a bending process to the board so that both edges thereof face each other.

In another aspect of the present invention, there is provided a method of manufacturing an automobile heat exchanger having a header formed integrally with a tank.

In accordance with an embodiment, the present invention provides a method of an automobile heat exchanger having a header formed integrally with a tank, which comprises a plurality of tubes through which a heat exchanging fluid flows and which are spaced apart from one another at a predetermined distance, a top header pipe unit to be operatively connected to top ends of the tubes, and a bottom header pipe unit to be operatively connected to bottom ends of the tubes, and the method comprises steps of: forming a board member with a clad material in a cylindrical pipe shape and welding both facing ends thereof, to form first, second, third and fourth header pipes; drawing each of the first, second, third and fourth header pipes, to form a flat surface at one lengthwise side thereof; forming tube inserting holes at each header pipe to be operatively connected to the tubes; connecting an entrance/exit end cap and an end cap to both ends of each of the first and second header pipes, to form the top header pipe unit formed of a pair of the first and second header pipes; forming the bottom header pipe unit formed of a pair of the third and fourth header pipes, and forming a plurality of refrigerant flowing means, bored to be spaced apart at a predetermined distance at one lengthwise side of the third and fourth header pipes, in the same shape and in the same number, so as to face each other at a joint part between the third and fourth header pipes, so that the heat exchanging fluid flows between the third and fourth header pipes; connecting end caps to both ends of each of the third and fourth header pipes to be securely assembled together; extrusion-molding tubes including a plurality of protrusions formed around tube holes, to expand a heat transfer area; and operatively connecting the top header pipe unit and the bottom header pipe unit to both ends of the tubes.

In accordance with another embodiment, the present invention provides a method of an automobile heat exchanger having a header formed integrally with a tank, which comprises a plurality of tubes through which a heat exchanging fluid flows and which are spaced apart from one another at a predetermined distance, a top header pipe unit to be operatively connected to top ends of the tubes, and a bottom header pipe unit to be operatively connected to bottom ends of the tubes, and the method comprises steps of: forming first, second, third and fourth header pipes by extrusion-molding a casting in a pipe shape including a surface; forming tube inserting holes at the first, second, third and fourth header pipes to be operatively connected to the tubes; forming a flat surface at one lengthwise side of each of the first and second header pipes so as to correspond to each other and to be joined at the side so that the first and second header pipes are securely assembled together, and after interposing a clad material between the first and second header pipes, connecting an entrance/exit end cap and an end cap to both ends of each of the first and second header pipes, to form the top header pipe unit formed of a pair of the first and second header pipes; forming the bottom header pipe unit formed of a pair of the third and fourth header pipes, and forming a plurality of refrigerant flowing means bored to be spaced apart at a predetermined distance at one lengthwise side of each of the third and fourth header pipes, in the same shape and in the same number, so as to face each other at a joint part between the third and fourth header pipes, so that the heat exchanging fluid flows between the third and fourth header pipes; after interposing the clad material between the third and fourth header pipes, connecting end caps to both ends of each of the third and fourth header pipes to be securely assembled together; forming the tubes by forming an outer circumferential surface thereof using a board member with the clad material and then by inserting a heat transfer expanding member of a refrigerant inside; and operatively connecting the top header pipe unit and the bottom header pipe unit to both ends of the tubes.

### MODE FOR THE INVENTION

Embodiments of the present invention will now be described more fully hereinafter with reference to the accompanying drawings.

It will be understood that the terms or words used in the specification and claims shall not be interpreted as the meanings and concepts defined in commonly used dictionaries. It will be further understood that these terms shall be interpreted as the meanings and concepts to meet the technical idea of the present invention, based on the principle that an inventor may properly define the meaning or concept of a term or word to explain the invention in a best way.

Accordingly, it should be understood that since the constitution disclosed in the embodiments and drawings of the present invention does not represent all technical ideas of the present invention, the embodiments and drawings of the invention are to cover all modifications, equivalents, and alternatives falling within the scope of the invention.

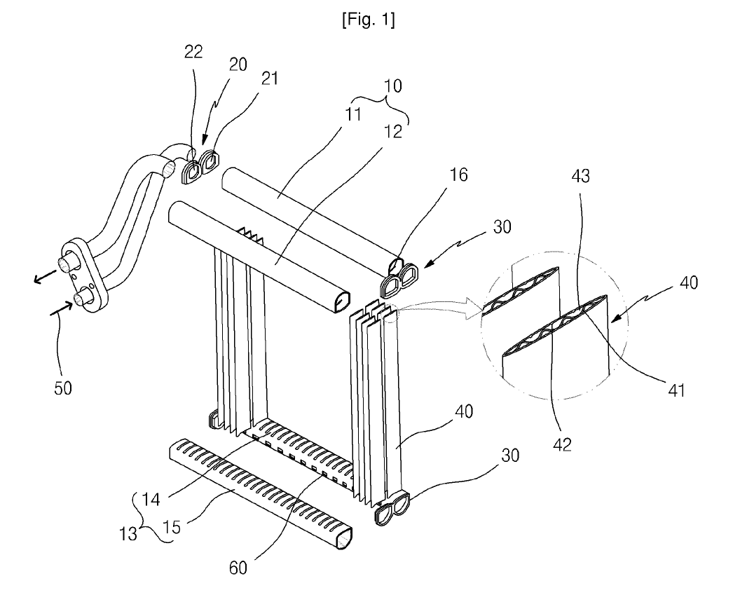

An automobile heat exchanger having a header formed integrally with a tank and a method of manufacturing the same in accordance with the embodiments of the present invention will be described in detail with reference to FIGS. 1 through 14.

As illustrated, in an automobile heat exchanger having a header formed integrally with a tank and a method of manufacturing the same in accordance with the present invention, a pair of header pipes each having a header formed integrally with a tank are connected to a top end and a bottom end of a tube. The header pipe is manufactured in a welded type or a folded type. The heat exchanger includes a top header pipe unit 10, a bottom header pipe unit 13, a first header pipe 11, a second header pipe 12, an entrance/exit end cap 20 and 20′ an end cap 30, a third header pipe 14, a fourth header pipe 15, a refrigerant flowing means 60, a protrusion 42, and a heat transfer expanding member 41.

FIG. 1 is a perspective view of a heat exchanger according to an embodiment of the present invention. As illustrated in FIG. 1, the first header pipe 11 and the second header pipe 12 manufactured by forming a board member with a clad material in a pipe shape and drawing the pipe-shaped board member are positioned to be parallel to each other lengthwise and are brazed, to form the top header pipe unit 10.

Each of the first header pipe 11 and the second header pipe 12 is formed in a pipe shape including a side and has a flat surface 31. The first header pipe 11 and the second header pipe 12 are positioned so that their respective flat surfaces 31 are positioned to be connected to each other.

The top header pipe unit 10 including the first and second header pipes 11 and 12 is formed by brazing the portion of the flat surface 31. During the brazing, a clad member or a clad paste is interposed between the first header pipe 11 and the second header pipe 12 so that the first and second header pipes 11 and 12 are welded integrally. A method of manufacturing the first header pipe 11 and the second header pipe 12 will be later described in detail.

Among a plurality of the header pipes which are formed, a plurality of the header pipes forming the top header pipe unit 10 to be connected to the top ends of tubes 40 are indicated as the first header pipe 11 and the second header pipe 12.

The aforementioned method is applied to not only the first header pipe 11 and the second header pipe 12 but also the third header pipe 14 and the fourth header pipe 15 which will be later described.

One end of the top header pipe unit 10 formed of the first header pipe 11 and the second header pipe 12 is connected to an entrance/exit end cap 20 forming an inlet aperture 21 and an outlet aperture 22 through which a heat exchanging fluid 50 flows in/out, and the other end thereof is connected to an end cap 30.

That is, the inlet aperture 21 of the entrance/exit end cap 20 is connected to one end of the first header pipe 11 of the top header pipe unit 10, and the outlet aperture 22 is connected to one end of the second header pipe 12. The entrance/exit end cap 20 allows the heat exchanging fluid 50 to flow in/out and securely connects the first header pipe 11 and the second header pipe 12, together with the end cap 30.

The bottom header pipe unit 13 is formed of the third header pipe 14 and the fourth header pipe 15. A method of manufacturing the third header pipe 14 and the fourth header pipe 15 is the same as the method of manufacturing the first header pipe 11 and the second header pipe 12, which will be later described in detail. But, the third header pipe 14 and the fourth header pipe 15 each include refrigerant flowing means 60 formed on a side to be joined together, so that the heat exchanging fluid 50 flows through the refrigerant flowing means 60. The refrigerant flowing means 60 are formed to face each other in the third header pipe 14 and the fourth header pipe 15. The refrigerant flowing means 60 are formed in the same direction as that in which the heat exchanging fluid 50 flows into one side of the first header pipe 11 and progressively flows lengthwise. The refrigerant flowing means 60 are positioned at a predetermined distance and are formed so that their respective diameters progressively decrease or increase.

Both ends of the bottom header pipe unit 13 formed of the third header pipe 14 and the fourth header pipe 15 are connected to an end cap 30, to improve a connection force of the third header pipe 14 and the fourth header pipe 15.

The top header pipe unit 10 and the bottom header pipe unit 13 each form a header unit of a plurality of columns. The tubes 40 are respectively connected to tube inserting holes 16 formed to be spaced apart from one another at a predetermined interval at one side of each of the first, second, third and fourth header pipes 11, 12, 14 and 15.

That is, the top header pipe unit 10 is connected to the top end of the tube 40 and the bottom header pipe unit 13 is connected to the bottom end of the tube 40. An outer circumferential surface of the tube 40 is formed by a board member with a clad material. A plurality of protrusions 42 for expanding a heat transfer area are formed around a tube hole 43 to be connected to the tube inserting hole 16 by extrusion molding. Subsequently, a heat transfer expanding member 41 of the refrigerant is inserted into the tube hole 43.

To again explain FIG. 1 in summary, FIG. 1 illustrates the heat exchanger in which, after each of the first, second, third and fourth header pipes 11, 12, 14 and 15 having the header formed integrally with the tank is manufactured, the top header pipe unit 10 is formed by positioning the flat surfaces 31 formed in the first header pipe 11 and the second header pipe 12 lengthwise to be parallel to each other, the bottom header pipe unit 13 is formed by positioning the flat surfaces 31 of the third header pipe 14 and the fourth header pipe 15 to be parallel to each other like those of the first and second header pipes 11 and 12, and the top ends and bottom ends of the tubes 40 through which the heat exchanging fluid flows are respectively connected to the tube inserting holes 16 bored on the outer circumferential surfaces of the top header pipe unit 10 and bottom header pipe unit 13 lengthwise so as to be spaced apart from one another at a predetermined distance.

As illustrated in FIG. 1, on the flat surfaces 31 of the third header pipe 14 and fourth header pipe 15 forming the bottom header pipe unit 13, the refrigerant flowing means 60 for allowing the heat exchanging fluid to flow are bored to correspond to each other between the third and fourth header pipes 14 and 15 and to be operatively connected therebetween.

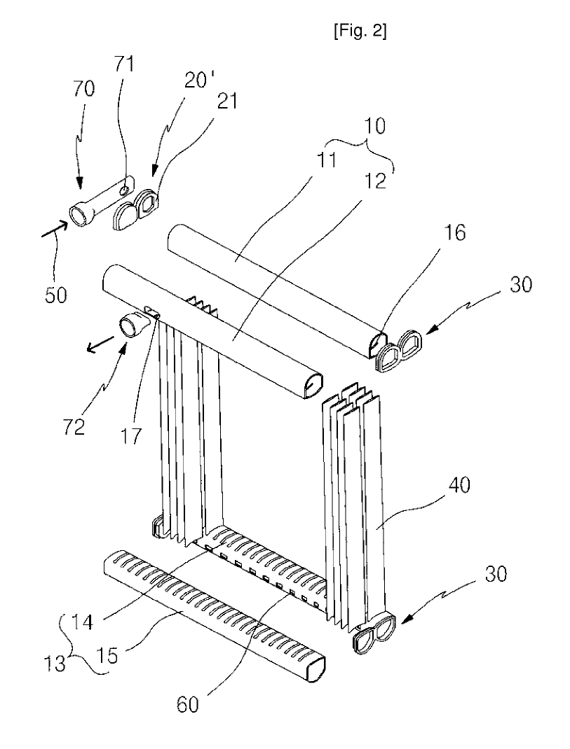

FIG. 2 is a perspective view of a heat exchanger according to another embodiment of the present invention. As illustrated in FIG. 2, the top header pipe unit 10 formed of the first and second header pipes 11 and 12 and the bottom header pipe unit 13 formed of the third and fourth header pipes 14 and 15 are respectively connected to both ends of each tube 40. A method of manufacturing the first and second header pipes 11 and 12 forming the top header pipe unit 10 and the third and fourth header pipes 14 and 15 forming the bottom header pipe unit 13 will be later described in detail, and an inter-connection relationship therebetween is the same as that described with reference to FIG. 1.

But, an entrance/exit end cap 20′ to be connected to one end of each of the first and second header pipes 11 and 12 forms an inlet aperture 21 to be operatively connected to an inlet hole 71 of an inlet manifold 70 through which the heat exchanging fluid 50 flows. When the inlet aperture 21 is operatively connected to one end of the first header pipe 11 and the heat exchanging fluid 50 flows into the first header pipe 11, one end of the second header pipe 12 is shut off.

Further, the second header pipe 12 includes a connection hole 17 formed at one side of the outer circumferential surface thereof lengthwise. The connection hole 17 is connected to an outlet manifold 72 so that the heat exchanging fluid 50 is discharged outward by the outlet manifold 72.

The other end of each of the first and second header pipes 11 and 12 forming the top header pipe unit 10 is connected to an end cap 30 so as to be closed.

Both ends of each of the third and fourth header pipes 14 and 15 are connected to the end caps 30 so as to be closed. The third header pipe 14 and the fourth header pipe 15 each include refrigerant flowing means 60 formed on a side to be joined together, so that the heat exchanging fluid 50 flows through the refrigerant flowing means 60. The refrigerant flowing means 60 are formed to face each other in the third header pipe 14 and the fourth header pipe 15.

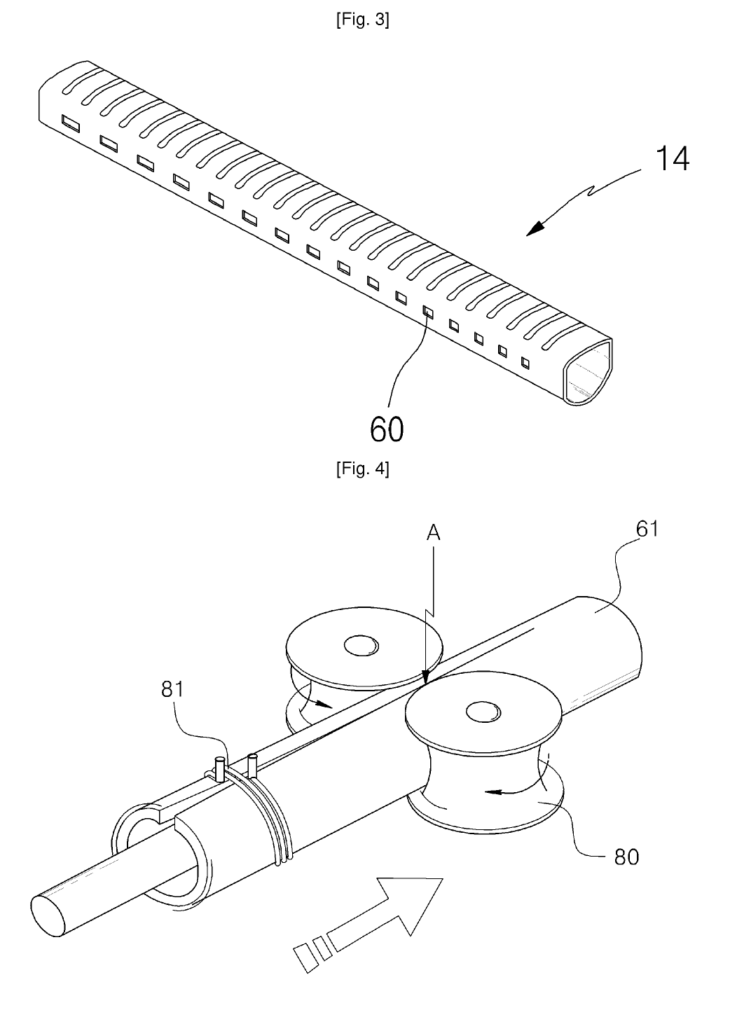

The refrigerant flowing means 60 are formed in the same direction as that in which the heat exchanging fluid 50 flows into one side of the first header pipe 11 and progressively flows lengthwise. The refrigerant flowing means 60 are positioned at a predetermined distance and are formed so that their respective diameters progressively decrease or increase, which will be described with reference to FIG. 3.

FIG. 3 is a perspective view of the refrigerant flowing means 60 according to the present invention. As illustrated, FIG. 3 shows the third header pipe 14. Other refrigerant flowing means 60 which respectively face the refrigerant flowing means 60 formed in the third header pipe 14 will be formed on the fourth header pipe 15 to be brazed with the third header pipe 14 lengthwise.

As illustrated, the refrigerant flowing means 60 are formed from one side to the other side. In these refrigerant flowing means 60, their respective diameters progressively decrease lengthwise. The direction in which the diameters decrease is the same as that in which the heat exchanging fluid 50 flows into the first header pipe 11 and flows within the pipe lengthwise. Further, the refrigerant flowing means 60 may be formed so that their respective diameters progressively increase lengthwise in contrary to FIG. 3. Each refrigerant flowing means 60 is bored in a square shape in FIG. 3 but it may be bored in various shapes, such as a round shape or a rectangular shape, by the selection of an operator or a user.

Further, in Table 1 given below, a ratio of radiant heat of the heat exchanger according to the present invention is compared to that of a conventional heat exchanger. As a result of comparatively measuring a ratio of radiant heat of the conventional heat exchangers disclosed in U.S. Pat. No. 6,272,881, B1, (Example 1) and Korean Patent Laid-Open Publication 10-2004-0069048 (Example 2) to that of the automobile heat exchanger having the header formed integrally with the tank according to the present invention, it indicates the present invention>10-2004-0069048>U.S. Pat. No. 6,272,881, B1, to prove that the present invention has the effect of generally improving the performance.

TABLE 1

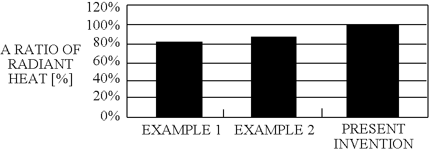

<Comparison of a ratio of radiant heat of the heat exchanger according to the present invention to that of each of conventional heat exchangers disclosed in U.S. Pat. No. 6,272,881B1 (Example 1) and 10-2004-0069048 (Example 2)>

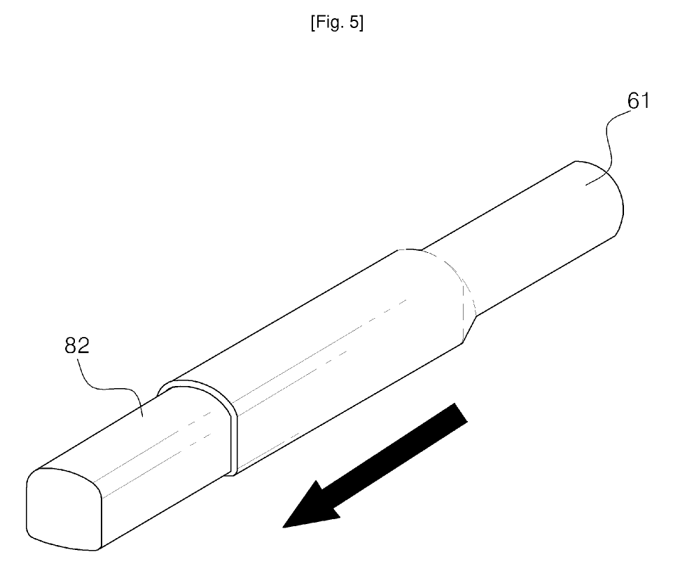

FIGS. 4 and 5 illustrate a first exemplary view of a method of manufacturing a header pipe according to the present invention. As illustrated, FIGS. 4 and 5 illustrate a method of manufacturing each of the first, second, third and fourth header pipes 11, 12, 14 and 15, which are described with reference with FIGS. 1 through 3, in a welded type.

FIGS. 4 and 5 illustrate the sequentially-continuing method. As illustrated in FIG. 4, to manufacture a board 61 with a clad material to be a round pipe, an induction coil 81 is wound around an outer circumferential surface of the board 61 for manufacturing the header pipe, to form a loop. A current is applied for forming of the board 61. While the board 61 is moved between a pair of pressure rollers 80 which are spaced apart from each other at a predetermined distance and rotate, both edges of the board 61 are joined by high frequency welding. In FIG. 4, the ‘A’ portion is to be welded.

The board 61 manufactured in the cylindrical shape is cut to be a size desired by a user. As illustrated in FIG. 5, a drawing tool 82 having a desired shape for a header pipe is inserted into the board 61 manufactured in the cylindrical shape, to form the header pipe desired by the user.

Preferably, a thickness of the board 61 may be 0.5 to 1.5 mm. When the thickness of the board 61 is under 0.5 mm, the material cost is reduced but the corrosion resistance and the pressure capability decrease. When the thickness of the board 61 is above 1.5 mm, the corrosion resistance and the pressure capability are good but the material cost increases. Accordingly, when the board having the thickness within 0.5 to 1.5 mm is used, the material cost is reduced and the corrosion resistance and the pressure capability are good.

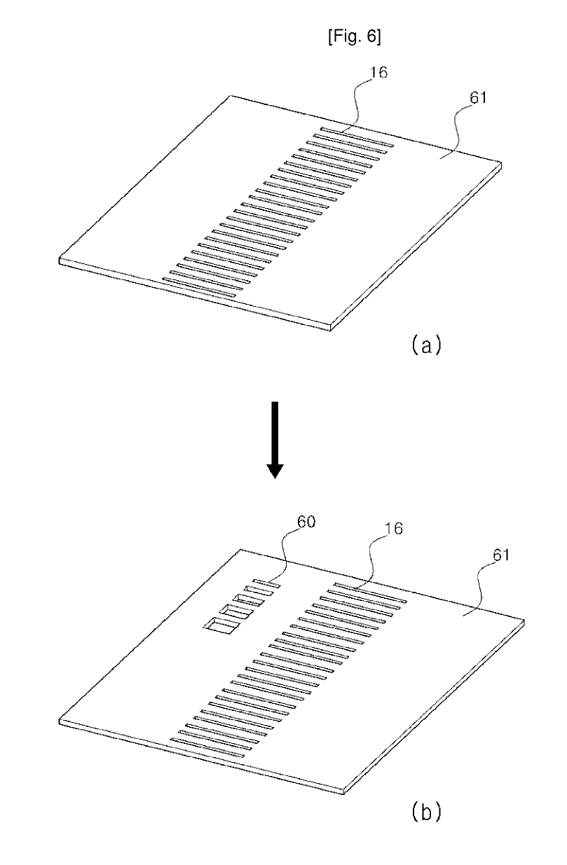

FIGS. 6 and 7 illustrate a second exemplary view of a method of manufacturing a header pipe according to the present invention. As illustrated, FIGS. 6 and 7 illustrate a different method of manufacturing a header pipe from that of FIGS. 4 and 5. The method of manufacturing a header pipe illustrated in FIGS. 6 and 7 is a folded type. FIG. 6 illustrates a pressing process.

In (a) of FIG. 6, a plurality of the tube inserting holes 16 are bored by a pressing process. The tubes 40 of FIG. 1 or FIG. 2 are inserted into the board 61 with the clad material for manufacturing each header pipe, through the tube inserting holes 16.

Subsequently, a plurality of the refrigerant flowing means 60 are selectively bored at either side of the bored tube inserting holes 16 by the pressing process. The refrigerant flowing means 60 may be bored to be spaced apart from one another at a predetermined distance. Further, as illustrated in (b) of FIG. 6, the refrigerant flowing means 60 may be bored to progressively decrease or increase in size toward any one side.

To manufacture the heat exchanger having two fluid passages in the same shape illustrated in FIG. 1 or FIG. 2, preferably, the refrigerant flowing means 60 may be bored only in the third header pipe 14 and the fourth header pipe 15. Further, as illustrated in (b) of FIG. 6, the refrigerant flowing means 60 are bored on the flat surfaces 31 of the third and fourth header pipes 14 and 15 which are connected to each other, that is, at one side of the tube inserting holes 16 so that the heat exchanging fluid operatively flows between the third and fourth header pipes 14 and 15.

FIG. 7 illustrates a folding process and a bending process. After the process of (a) and (b) of FIG. 6 is sequentially performed, the process of (c) and (d) of FIG. 7 is sequentially performed. As illustrated in (c) and (d) of FIG. 7, after the flat surface 31 is formed in each board 61 including the bored refrigerant flowing means 60 and tube inserting holes 16 by the folding process, the processed board 61 is bended by the bending process so that both edges of the board 61 face each other and are joined upon brazing. Then, when the flat surface 31 is formed by the folding process, preferably, the folding process may be performed at the portion spaced from both ends of each of the tube inserting holes 16 by at least 0.2 mm or more, to form the flat surface 31. When the distance between the flat surface 31 formed by the folding process and the tubes inserted into the tube inserting holes 16 is 0.2 mm or less, the clad material rises along the distance by a capillary phenomenon upon brazing, to close the tube hole. Therefore, the distance of at least 0.2 mm is needed.

Further, as illustrated in (d) of FIG. 7, when the flat surfaces 31 of the third and fourth header pipes 14 and 15 are connected to each other to form the bottom header pipe unit 13, the refrigerant flowing means of the third and fourth header pipes 14 and 15 are also joined to be operatively connected to each other.

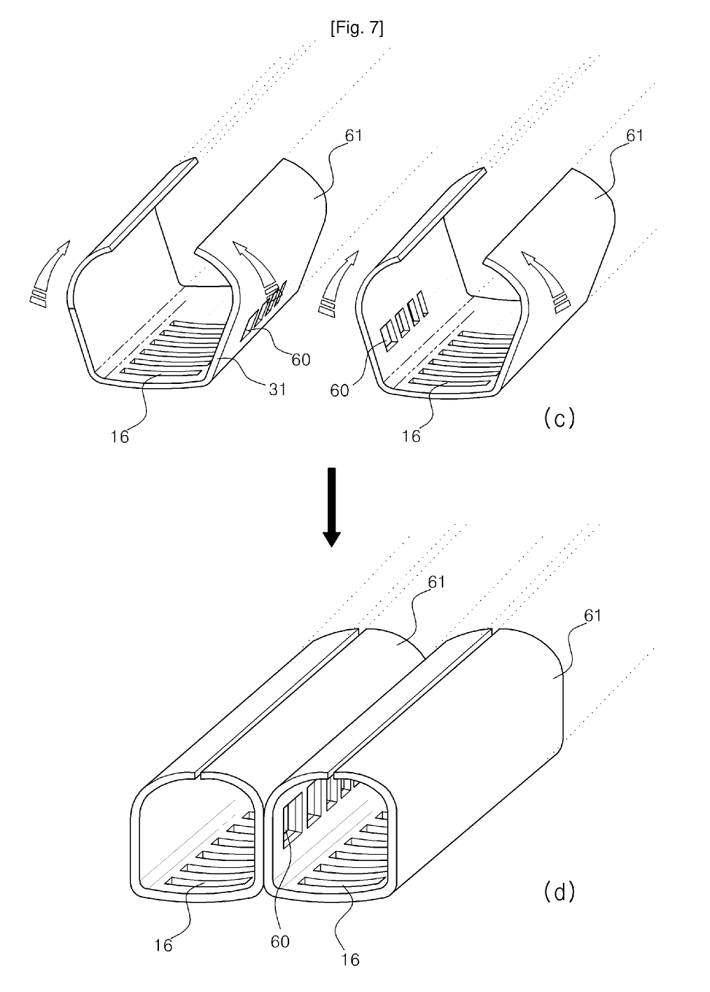

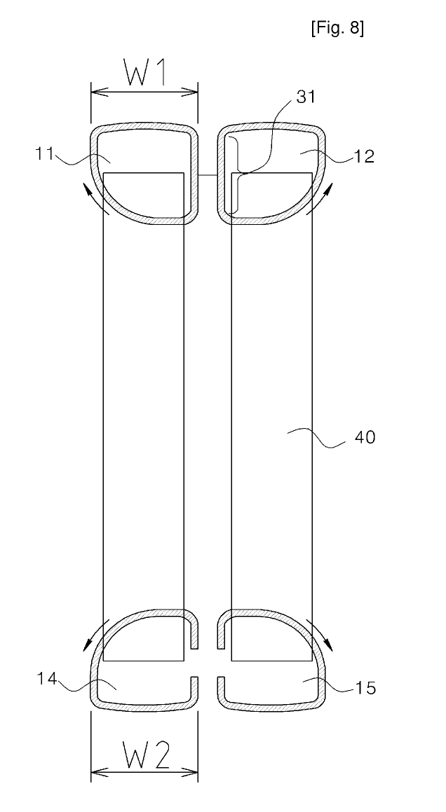

FIG. 8 is a sectional view of an example of the header pipe according to the present invention. As illustrated, FIG. 8 illustrates a shape of the header pipes used for the heat exchanger, that is, the first, second, third and fourth header pipes 11, 12, 14 and 15 according to the embodiment. As illustrated in FIG. 8, the top header pipe unit 10 may be manufactured to have a widthwise sectional shape W1 in which the sides of the first and second header pipes 11 and 12 connected to each other are drawn downward, and the bottom header pipe unit 13 may be manufactured to have a widthwise sectional shape W2 in which the sides of the third and fourth header pipes 14 and 15 connected to each other are drawn upward.

That is, the first and second header pipes 11 and 12 of FIG. 8 have the shape in which the flat surfaces 31 thereof to be connected to each other are drawn downward, and the third and fourth header pipes 14 and 15 have the shape in which the portions of the flat surfaces 31 thereof to be connected to each other are drawn upward. When the widthwise section shape of each of the header pipe units is controlled, the condensate generated on the surface of the header pipes can be easily discharged outward.

Further, the first, second, third and fourth header pipes 11, 12, 14 and 15 may be manufactured in a ‘D’ shape in which the flat surface 31 is formed at one side lengthwise.

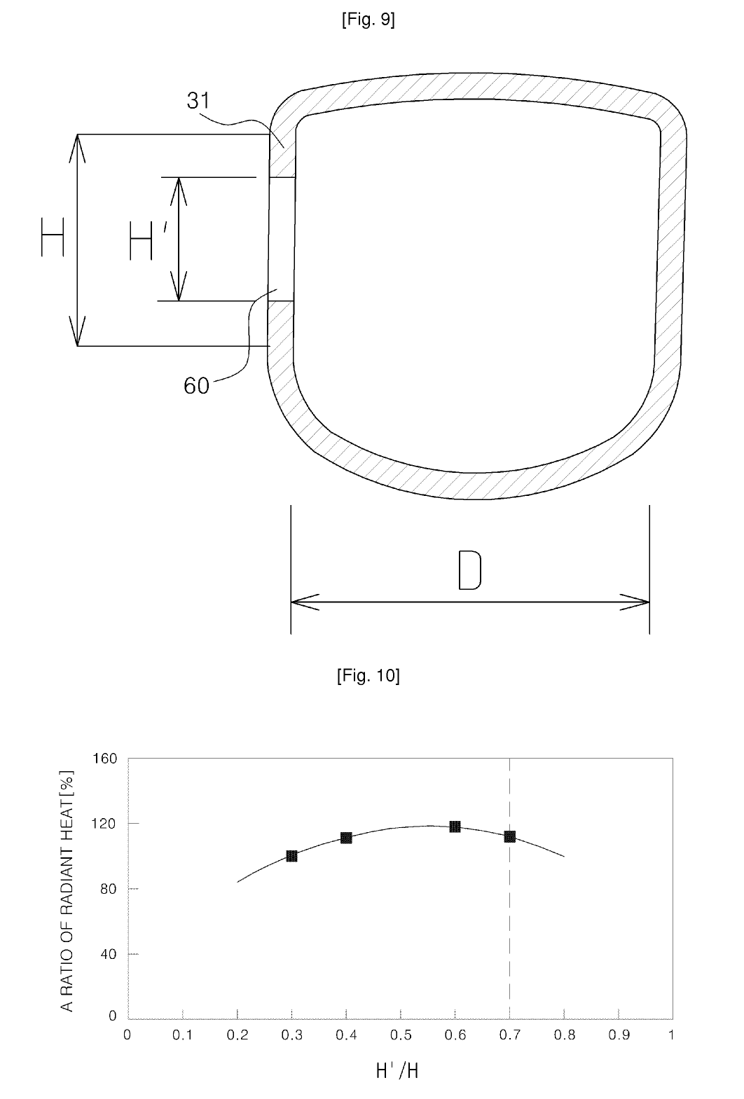

FIG. 9 is a sectional view of the refrigerant flowing means and the flat surface according to the present invention. FIG. 9 illustrates a height H of the flat surface 31 of the header pipe and a height H′ of the refrigerant flowing means 60 bored in the flat surface 31. A ratio of the height H′ of the refrigerant flowing means 60 to the height H of the flat surface 31,

$$\frac{{H}^{′}}{H}$$

(hereinafter, referred to as the “optimum ratio”.), has the influence on the heat radiation capability, the refrigerant pressure drop and the leak occurrence to be described below.

FIG. 10 is a graph of the correlation between the flat surface and the refrigerant flowing means and a ratio of radiant heat according to the present invention. FIG. 10 illustrates experimental values on the optimum ratio to provide the effective heat ration. That is, the graph of FIG. 10 represents the relation of a ratio of radiant heat of the heat exchanger to the optimum ratio. A ratio of radiant heat is indicated by a relative percentage to the optimum ratio, based on a ratio of radiant heat (100%) when the optimum ratio is 0.3. As illustrated in FIG. 10, when the optimum ratio is 0.3 to 0.7, a ratio of radiant heat is generally high, and when the optimum ratio is about 0.6, a ratio of radiant heat is highest.

FIG. 11 is a graph of the correlation between the flat surface and the refrigerant flowing means and the pressure drop of a refrigerant according to the present invention. FIG. 11 illustrates a pressure drop rate of the refrigerant which flows inside the heat exchanger by the resistance of a passage, to the optimum ratio. The pressure drop rate is indicated by a relative percentage to the optimum ratio, based on the pressure drop rate (100%) when the optimum ratio is 0.3. When the optimum ratio is about 0.3 or above, the pressure drop rate of the refrigerant does not show any big difference, however, when the optimum ratio is under 0.3, the pressure drop rate rapidly increases.

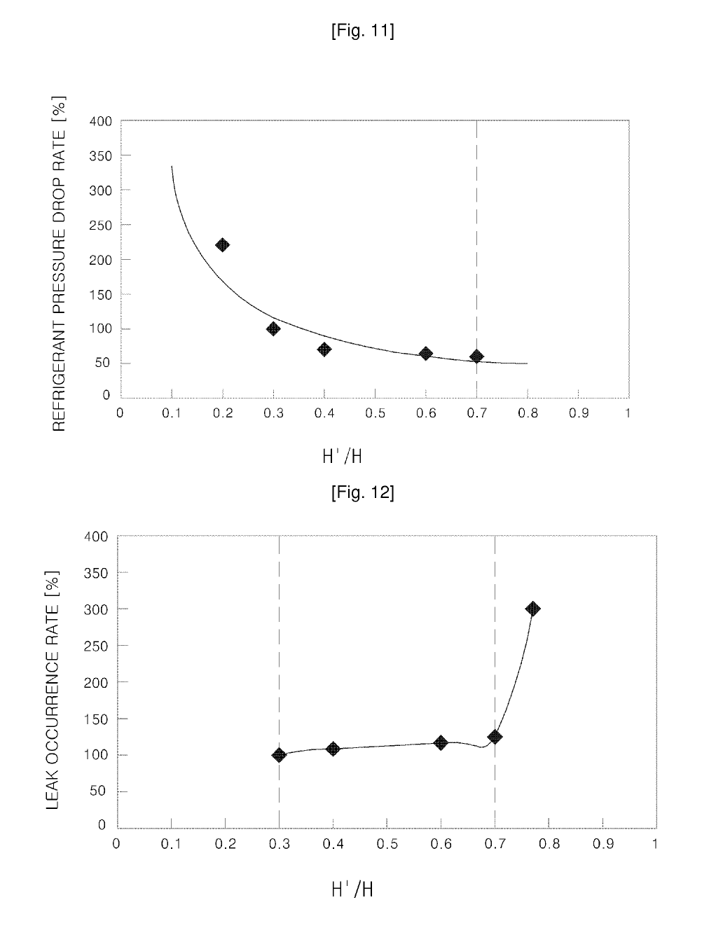

FIG. 12 is a graph of the correlation between the flat surface and the refrigerant flowing means and the leak occurrence at a joint part of the flat surfaces 31 of the header pipes according to the present invention. FIG. 12 illustrates the leak occurrence rate at a brazing joint part on the flat surfaces 31 to the optimum ratio. After the flat surfaces 31 of the header pipes including the refrigerant flowing means 60 are connected to form a pair of the header pipe unit and are brazed, leak occurs at the brazing joint part of the flat surfaces 31. The leak occurrence rate is indicated by a relative percentage to the optimum ratio, based on the leak occurrence rate (100%) when the optimum ratio is 0.3. When the optimum ratio is under 0.7, the leak occurrence rate is low and is little changed. However; when the optimum ratio is 0.7 or above, the leak occurrence rate rapidly increases.

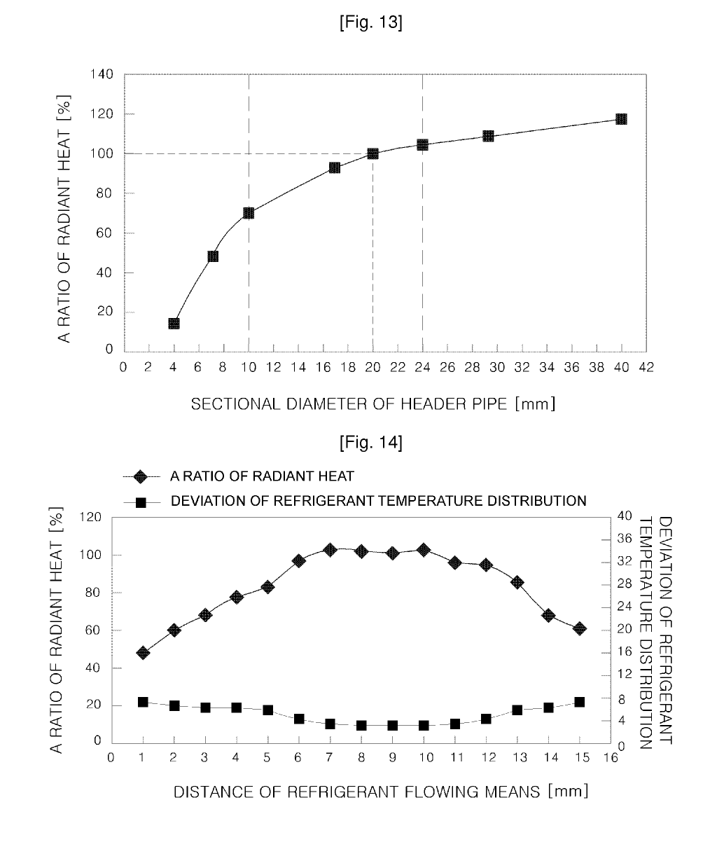

FIG. 13 is a graph of the correlation between the sectional diameter of the header pipe and a ratio of radiant heat. Referring to FIG. 9, the header pipe of FIG. 9 has the flat surfaces at both sides thereof. FIG. 13 illustrates a ratio of radiant heat to a change in the distance between the flat surfaces, that is, the sectional diameter D of the header pipe. In FIG. 13, a ratio of radiant heat is indicated by a relative percentage to the sectional diameter of each header pipe, based on a ratio of radiant heat (100%) when the sectional diameter of the header pipe is 20 mm. When the sectional diameter D of the header pipe increases, the width of the heat exchanger increases. Accordingly, a ratio of radiant heat is proportional to the sectional diameter (width) of the header pipe. As illustrated in FIG. 13, within the range of 10 to 24 mm, the sectional diameter of the header pipe is minimized and a ratio of radiant heat is optimized.

FIG. 14 is a graph of the correlation between a ratio of radiant heat to the distance of the refrigerant flowing means formed on the flat surface of the header pipe and the deviation of refrigerant temperature distribution of an evaporator. Generally, as the deviation in the refrigerant temperature distribution of the heat exchanger is less, a ratio of radiant heat is high. In FIG. 14, a ratio of radiant heat is indicated by a relative percentage to the distance of the refrigerant flowing means, based on a ratio of radiant heat (100%) when the distance of the refrigerant flowing means is 8 mm. In FIG. 14, a ratio of radiant heat is high and the deviation of the refrigerant temperature distribution is low within the specific range of the distance of the refrigerant flowing means, and then, the optimum distance of the refrigerant flowing means is 6 to 12 mm. That is, when the distance of the refrigerant flowing means is under 6 mm or above 12 mm, the deviation of the refrigerant temperature distribution is high and a ratio of radiant heat is low, so that the heat exchanging performance decreases. However, when the distance of the refrigerant flowing means is within the range of 6 to 12 mm, the deviation of the refrigerant temperature distribution is low and a ratio of radiant heat is high, so that the heat exchanging performance is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-17. (canceled)

18. An automobile heat exchanger having a header formed integrally with a tank, comprising:
a plurality of tubes (40) through which a heat exchanging fluid (50) flows and which are spaced apart from one another at a predetermined distance, a top header pipe unit (10) to be connected to top ends of the tubes (40), and a bottom header pipe unit (13) to be connected to bottom ends of the tubes (40);
wherein the top header pipe unit (10) is formed of a pair of header pipes (11 and 12) and the bottom header pipe unit (13) is formed of a pair of header pipes (14 and 15), each header pipe formed of one component so that the header is formed integrally with the tank, and the header pipes (11, 12, 14 and 15) respectively have a flat surface (31) formed at its one side of the header pipe so as to be connected each other at the one side;
wherein the top header pipe unit (10) comprises: the first header pipe (11) into which the heat exchanging fluid (50) flows, the second header pipe (12) from which the heat exchanging fluid (50) flows out, an entrance/exit end cap (20) to be connected to one end of each of the first and second header pipes (11 and 12) and forming an inlet aperture (21) and an outlet aperture (22) for the heat exchanging fluid (50), and an end cap (30) to be connected to the other end of each of the first and second header pipes (11 and 12) so as to securely assemble the first and second header pipes (11 and 12) together; and
wherein the bottom header pipe unit (13) comprises: the third header pipe (14) for receiving the heat exchanging fluid (50) flowing from the first header pipe (11), the fourth header pipe (15) for flowing the heat exchanging fluid (50) into the second header pipe (12), a plurality of refrigerant flowing holes (60) bored to be spaced apart at a predetermined distance at one side of each of the third and fourth header pipes (14 and 15), in the same shape and in the same number, so as to face each other at a joint part between the third and fourth header pipes (14 and 15), so that the heat exchanging fluid (50) flows between the third and fourth header pipes (14 and 15), and a pair of end caps (30) to be each connected to both ends of each of the third and fourth header pipes (14 and 15) to securely assemble the third and fourth header pipes (14 and 15) together,
wherein the refrigerant flowing holes (60) has a shape in which its area progressively decreases or increases toward one side of the third and fourth header pipes (14 and 15),
wherein the first, second, third and fourth header pipes (11, 12, 14 and 15) respectively have a sectional shape of a “D” in which the flat surface (31) is formed at one lengthwise side,
wherein the width (W1) of the first and second header pipes (11 and 12) is narrowed downwardly, and the width (W2) of the third and fourth header pipes (14 and 15) is widened downwardly.

19. An automobile heat exchanger having a header formed integrally with a tank, comprising:
a plurality of tubes (40) through which a heat exchanging fluid (50) flows and which are spaced apart from one another at a predetermined distance, a top header pipe unit (10) to be connected to top ends of the tubes (40), and a bottom header pipe unit (13) to be connected to bottom ends of the tubes (40);
wherein the top header pipe unit (10) is formed of a pair of header pipes (11 and 12) and the bottom header pipe unit (13) is formed of a pair of header pipes (14 and 15), each header pipe formed of one component so that the header is formed integrally with the tank, and the header pipes (11, 12, 14 and 15) respectively have a flat surface (31) formed at one side of the header pipe so as to be connected each other at the one side;
wherein the top header pipe unit (10) comprises: the first header pipe (11) connecting an inlet manifold (70) so that the heat exchanging fluid (50) flows into, the second header pipe (12) connecting an outlet manifold (72) so that the heat exchanging fluid (50) flows out, an entrance/exit end cap (20′) to be connected to one end of each of the first and second header pipes (11 and 12) and forming an inlet aperture (21) for the heat exchanging fluid (50), and an end cap (30) to be connected to the other end of each of the first and second header pipes (11 and 12) so as to securely assemble the first and second header pipes (11 and 12) together; and
wherein the bottom header pipe unit (13) comprises: the third header pipe (14) for receiving the heat exchanging fluid (50) flowing from the first header pipe (11), the fourth header pipe (15) for flowing the heat exchanging fluid (50) into the second header pipe (12), a plurality of refrigerant flowing holes (60) bored to be spaced apart at a predetermined distance at one side of each of the third and fourth header pipes (14 and 15), in the same shape and in the same number, so as to face each other at a joint part between the third and fourth header pipes (14 and 15), so that the heat exchanging fluid (50) flows between the third and fourth header pipes (14 and 15), and a pair of end caps (30) to be each connected to both ends of each of the third and fourth header pipes (14 and 15) to securely assemble the third and fourth header pipes (14 and 15) together,
wherein the refrigerant flowing holes (60) has a shape in which its area progressively decreases or increases toward one side of the third and fourth header pipes (14 and 15),
wherein the first, second, third and fourth header pipes (11, 12, 14 and 15) respectively have a sectional shape of a “D” in which the flat surface (31) is formed at one lengthwise side,
wherein the width (W1) of the first and second header pipes (11 and 12) is narrowed downwardly, and the width (W2) of the third and fourth header pipes (14 and 15) is widened downwardly.

20. The automobile heat exchanger according to claim 18, wherein each of the first, second, third and fourth header pipes (11, 12, 14 and 15) is formed by rolling a plate (61) with a clad material in a cylindrical shape, welding both facing edges thereof, and passing the welded cylindrical plate (61) through a drawing metal mold.

21. The automobile heat exchanger according to claim 18, wherein each of the first, second, third and fourth header pipes (11, 12, 14 and 15) is formed by forming tube inserting holes (16) to receive the tubes (40) and refrigerant flowing holes (60) by performing a pressing process on the plate (61) with the clad material, forming the flat surface (31) by a folding process, and performing a bending process on the processed plate (61) to face both edges of the processed plate each other so that the both edges are joined together upon brazing.

22. The automobile heat exchanger according to claim 18, wherein the tube (40) having a tube hole (43) is manufactured by extrusion molding and includes a plurality of protrusions (42) for expanding a heat transfer area formed at the inner side or outer side of the tube hole (43) by the extrusion molding.

23. The automobile heat exchanger according to claim 18, wherein the tube (40) is manufactured by forming an outer circumferential surface using a plate with a clad, and by inserting a heat transfer expanding member (41) of a refrigerant inside.

24. The automobile heat exchanger according to claim 18, wherein a joint part between the first and second header pipes (11 and 12) and a joint part between the third and fourth header pipes (14 and 15) use a clad member or clad paste during a brazing process, so that each pair of the header pipes are integrally welded.

25. The automobile heat exchanger according to claim 18, wherein the first, second, third and fourth header pipes (11, 12, 14 and 15) respectively have a ratio of a height (H′) of the refrigerant flowing holes (60) to a height (H) of the flat surface (31) formed at the one side, within the range of 0.3 to 0.7.

26. The automobile heat exchanger according to claim 18, wherein the first, second, third and fourth header pipes (11, 12, 14 an 15) respectively have a thickness of the plate (61) within the range of 0.5 to 1.5 mm, and a sectional diameter (D) of the header pipe within the range of 10 to 24 mm.

27. The automobile heat exchanger according to claim 18, wherein the first, second, third and fourth header pipes (11, 12, 14 and 15) respectively have a distance between the refrigerant flowing holes (60) formed on the flat surface (31) at the one side, within the range of 6 to 12 mm.

28. A method of manufacturing the automobile heat exchanger according to claim 18, in which the first, second, third and fourth header pipes (11, 12, 14 and 15) are manufactured by steps of:
forming a plate (61) with a clad material in a cylindrical shape;
welding both facing edges of the plate (61) formed in the cylindrical shape;
passing the welded cylindrical plate (61) through a drawing metal mold so that the plate is drawn to form a flat surface (31) on one side thereof;
performing a pressing process to form tube inserting holes (16) at one side of the drawn plate (61); and
performing a pressing process to form refrigerant flowing holes (60) on the flat surface (31).

29. A method of manufacturing the automobile heat exchanger according to claim 18, in which the first, second, third and fourth header pipes (11, 12, 14 and 15) are manufactured by steps of:
performing a pressing process to form tube inserting holes (16) on a plate (61) with a clad material;
performing a pressing process to form refrigerant flowing holes (60) at a position corresponding to a flat surface (31);
performing a folding process to form the flat surface (31) at a position spaced apart from both ends of the tube inserting holes (16) by at least 0.2 mm or more; and
performing a bending process to the plate (61) so that both edges thereof face each other.

30. A method of an automobile heat exchanger having a header formed integrally with a tank, which comprises: a plurality of tubes (40) through which a heat exchanging fluid (50) flows and which are spaced apart from one another at a predetermined distance, a top header pipe unit (10) to be connected to top ends of the tubes (40), and a bottom header pipe unit (13) to be connected to bottom ends of the tubes (40),
the method comprising steps of:
forming a plate with a clad material in a cylindrical pipe shape and welding both facing ends thereof, to form first, second, third and fourth header pipes (11, 12, 14 and 15);
drawing each of the first, second, third and fourth header pipes (11, 12, 14 and 15), to form a flat surface at one side thereof;
forming tube inserting holes (16) at each header pipe (11, 12, 13, and 14) to be connected to the tubes (40);
connecting an entrance/exit end cap (20) and an end cap (30) to both ends of each of the first and second header pipes (11 and 12), to form the top header pipe unit (10) formed of a pair of the first and second header pipes (11 and 12);
forming the bottom header pipe unit (13) formed of a pair of the third and fourth header pipes (14 and 15), and forming a plurality of refrigerant flowing holes (60) bored to be spaced apart at a predetermined distance at one side of each of the third and fourth header pipes (14 and 15), in the same shape and in the same number, so as to face each other at a joint part between the third and fourth header pipes (14 and 15), so that the heat exchanging fluid (50) flows between the third and fourth header pipes (14 and 15);
connecting end caps (30) to both ends of each of the third and fourth header pipes (14 and 15) to be securely assembled together;
extrusion-molding the tubes (40) including a plurality of protrusions (42) formed around tube holes (43), to expand a heat transfer area; and
operatively connecting the top header pipe unit (10) and the bottom header pipe unit (13) to both ends of the tubes (40).

31. A method of an automobile heat exchanger having a header formed integrally with a tank, which comprises: a plurality of tubes (40) through which a heat exchanging fluid (50) flows and which are spaced apart from one another at a predetermined distance, a top header pipe unit (10) to be connected to top ends of the tubes (40), and a bottom header pipe unit (13) to be connected to bottom ends of the tubes (40),
the method comprising steps of:
forming first, second, third and fourth header pipes (11, 12, 14 and 15) by extrusion-molding a casting in a pipe shape including a surface;
forming tube inserting holes (16) at the first, second, third and fourth header pipes (11, 12, 14 and 15) to be connected to the tubes (40);
forming a flat surface at one lengthwise side of each of the first and second header pipes (11 and 12) so as to correspond to each other and to be joined at the side so that the first and second header pipes (11 and 12) are securely assembled together, and after interposing a clad material between the first and second header pipes (11 and 12), connecting an entrance/exit end cap (20) and an end cap (30) to both ends of each of the first and second header pipes (11 and 12), to form the top header pipe unit (10) formed of a pair of the first and second header pipes (11 and 12);
forming a plurality of refrigerant flowing holes (60) bored to be spaced apart at a predetermined distance at one side of each of the third and fourth header pipes (14 and 15), in the same shape and in the same number, so as to face each other at a joint part between the third and fourth header pipes (14 and 15), so that the heat exchanging fluid (50) flows between the third and fourth header pipes (14 and 15) to form the bottom header pipe unit (13) formed of a pair of the third and fourth header pipes (14 and 15);
after interposing the clad material between the third and fourth header pipes (14 and 15), connecting end caps (30) to both ends of each of the third and fourth header pipes (14 and 15) to be securely assembled together;
forming the tubes (40) by forming an outer circumferential surface thereof using a plate with the clad material and then by inserting a heat transfer expanding member (41) of a refrigerant inside; and
operatively connecting the top header pipe unit (10) and the bottom header pipe unit (13) to both ends of the tubes (40).

32. The automobile heat exchanger according to claim 19, wherein each of the first, second, third and fourth header pipes (11, 12, 14 and 15) is formed by rolling a plate (61) with a clad material in a cylindrical shape, welding both facing edges thereof, and passing the welded cylindrical plate (61) through a drawing metal mold.

33. The automobile heat exchanger according to claim 19, wherein each of the first, second, third and fourth header pipes (11, 12, 14 and 15) is formed by forming tube inserting holes (16) to receive the tubes (40) and refrigerant flowing holes (60) by performing a pressing process on the plate (61) with the clad material, forming the flat surface (31) by a folding process, and performing a bending process on the processed plate (61) to face both edges of the processed plate each other so that the both edges are joined together upon brazing.

34. The automobile heat exchanger according to claim 19, wherein the tube (40) having a tube hole (43) is manufactured by extrusion molding and includes a plurality of protrusions (42) for expanding a heat transfer area formed at the inner side or outer side of the tube hole (43) by the extrusion molding.

35. The automobile heat exchanger according to claim 19, wherein the tube (40) is manufactured by forming an outer circumferential surface using a plate with a clad, and by inserting a heat transfer expanding member (41) of a refrigerant inside.

36. The automobile heat exchanger according to claim 19, wherein a joint part between the first and second header pipes (11 and 12) and a joint part between the third and fourth header pipes (14 and 15) use a clad member or clad paste during a brazing process, so that each pair of the header pipes are integrally welded.

37. The automobile heat exchanger according to claim 19, wherein the first, second, third and fourth header pipes (11, 12, 14 and 15) respectively have a ratio of a height (H′) of the refrigerant flowing holes (60) to a height (H) of the flat surface (31) formed at the one side, within the range of 0.3 to 0.7.

38. The automobile heat exchanger according to claim 19, wherein the first, second, third and fourth header pipes (11, 12, 14 an 15) respectively have a thickness of the plate (61) within the range of 0.5 to 1.5 mm, and a sectional diameter (D) of the header pipe within the range of 10 to 24 mm.

39. The automobile heat exchanger according to claim 19, wherein the first, second, third and fourth header pipes (11, 12, 14 and 15) respectively have a distance between the refrigerant flowing holes (60) formed on the flat surface (31) at the one side, within the range of 6 to 12 mm.

40. A method of manufacturing the automobile heat exchanger according to claim 19, in which the first, second, third and fourth header pipes (11, 12, 14 and 15) are manufactured by steps of:
forming a plate (61) with a clad material in a cylindrical shape;
welding both facing edges of the plate (61) formed in the cylindrical shape;
passing the welded cylindrical plate (61) through a drawing metal mold so that the plate is drawn to form a flat surface (31) on one side thereof;
performing a pressing process to form tube inserting holes (16) at one side of the drawn plate (61); and
performing a pressing process to form refrigerant flowing holes (60) on the flat surface (31).

41. A method of manufacturing the automobile heat exchanger according to claim 19, in which the first, second, third and fourth header pipes (11, 12, 14 and 15) are manufactured by steps of:
performing a pressing process to form tube inserting holes (16) on a plate (61) with a clad material;
performing a pressing process to form refrigerant flowing holes (60) at a position corresponding to a flat surface (31);
performing a folding process to form the flat surface (31) at a position spaced apart from both ends of the tube inserting holes (16) by at least 0.2 mm or more; and
performing a bending process to the plate (61) so that both edges thereof face each other.
